(19) United States
(12) Patent Application Publication
(10) Pub. No.: US 2013/0227830 A1
(43) Pub. Date: Sep. 5, 2013

(54) MANUFACTURING METHOD OF OPTICAL FILM AND MANUFACTURING METHOD OF STEREOSCOPIC DISPLAY

(71) Applicants: Chun-Wei Su, New Taipei City (TW); Jan-Tien Lien, Keelung City (TW)

(72) Inventors: Chun-Wei Su, New Taipei City (TW); Jan-Tien Lien, Keelung City (TW)

(73) Assignee: CHUNGHWA PICTURE TUBES, LTD., Taoyuan (TW)

(21) Appl. No.: 13/552,656

(22) Filed: Jul. 19, 2012

(30) Foreign Application Priority Data
Mar. 3, 2012 (TW) 101107180

(51) Int. Cl. B05D 3/06; B23P 17/04; B05D 1/32

(52) U.S. Cl. 29/458; 427/508; 427/510

(57) ABSTRACT

A manufacturing method of an optical film includes following steps. An alignment solution is coated onto a first substrate having a first area and a second area. The alignment solution on the first substrate is exposed to a polarized light to form an optical alignment film having a first alignment direction and a second alignment direction on the two areas, respectively. A composite liquid crystal (LC) material containing a reactive LC material and a monomer material is coated onto the optical alignment film. The optical alignment film is sequentially exposed to a first non-polarized light having a monomer material absorption wavelength and a second non-polarized light having a reactive LC material absorption wavelength, thus the monomer material reacts with the reactive LC material, and the reactive LC material is solidified along the first and second alignment directions in sequence. A manufacturing method of a stereoscopic display is also provided.

### CROSS-REFERENCE TO RELATED APPLICATION

This application claims the priority benefit of Taiwan application serial no. 101107180, filed on Mar. 3, 2012. The entirety of the above-mentioned patent application is hereby incorporated by reference herein and made a part of this specification.

### BACKGROUND OF THE INVENTION

1. Field of the Invention

The invention relates to a manufacturing method of a film and a manufacturing method of a display. More particularly, the invention relates to a manufacturing method of an optical film and a manufacturing method of a stereoscopic display.

2. Description of Related Art

In recent years, the continuing progress of display technologies leads to increasing demands on display quality of displays (e.g., image resolution, color saturation, and so on). However, other than the requirements for high resolution and high color saturation, in order to satisfy the need of users to watch real images, stereo displays which are capable of displaying stereo images have been developed.

The stereo displays can be roughly divided into a stereoscopic display which requires a user to wear a specially designed pair of glasses, and an auto-stereoscopic display which directly allows a user to watch an image with naked eyes. According to the operating principle of the stereoscopic display, left and right eye frames containing specific messages are sent by the display, and the eye glasses are applied to select the displayed left and right eye frames, so that the left and right eyes respectively observe left and right eye frames for generating a three-dimensional (3D) visual effect. According to a conventional stereo display technique, a patterned optical anisotropic film (patterned phase retardation film) is configured in a display to enable a display frame to be separated into a left-eye visible area and a right-eye visible area, and thereby the 3D display effect may be achieved.

At present, according to a method of forming a patterned phase retardation film, an optical film is formed on a substrate. An alignment solution is then coated onto the glass substrate and exposed twice to two polarized light with respective polarization directions, which results in secondary alignment of an optical alignment film. Thereafter, a liquid crystal material is coated to form the optical film capable of displaying a circular polarization image. However, since the secondary alignment force of the secondary exposure is weaker, which also deteriorates the image quality of the stereoscopic display using the patterned phase retardation film. As such, a user, when watching the image displayed on the stereoscopic display, may need to deal with a color shift issue.

### SUMMARY OF THE INVENTION

The invention is directed to a manufacturing method of an optical film for accomplishing favorable secondary alignment.

The invention is further directed to a manufacturing method of a stereoscopic display for resolving a color shift issue of a stereo image.

In the invention, a manufacturing method of an optical film includes following steps. An alignment solution that includes a photo-polymerization alignment material is provided. The alignment solution is coated onto a first substrate which has a first area and a second area. The alignment solution on the first substrate is exposed to a polarized light, so as to form an optical alignment film on the first substrate. The optical alignment film on the first area has a first alignment direction, and the optical alignment film on the second area has a second alignment direction. A composite liquid crystal material that includes a reactive liquid crystal material and a monomer material is provided. The composite liquid crystal material is coated onto the optical alignment film that has the first alignment direction and the second alignment direction. A first non-polarized light having an absorption wavelength of the monomer material is provided, and the composite liquid crystal material on the optical alignment film is exposed to the first non-polarized light, such that the monomer material reacts with the reactive liquid crystal material. A second non-polarized light having an absorption wavelength of the reactive liquid crystal material is provided, and the reactive liquid crystal material on the optical alignment film is exposed to the second non-polarized light, such that the reactive liquid crystal material is solidified along the first alignment direction and the second alignment direction of the optical alignment film.

In the invention, another manufacturing method of an optical film includes following steps. A composite alignment solution that includes a photo-polymerization alignment material and a monomer material is provided. The composite alignment solution is coated onto a first substrate which has a first area and a second area. The composite alignment solution on the first substrate is exposed to a polarized light, so as to form an optical alignment film on the first substrate. The optical alignment film on the first area has a first alignment direction and the optical alignment film on the second area has a second alignment direction. A reactive liquid crystal material is provided. The reactive liquid crystal material is coated onto the optical alignment film that has the first alignment direction and the second alignment direction. A first non-polarized light having an absorption wavelength of the monomer material is provided, and the monomer material and the reactive liquid crystal material are exposed to the first non-polarized light, such that the monomer material reacts with the reactive liquid crystal material. A second non-polarized light having an absorption wavelength of the reactive liquid crystal material is provided, and the reactive liquid crystal material on the optical alignment film is exposed to the second non-polarized light, such that the reactive liquid crystal material is solidified along the first alignment direction and the second alignment direction of the optical alignment film.

According to an embodiment of the invention, a wavelength of the first non-polarized light ranges from 254 nm to 365 nm, and a wavelength of the second non-polarized light is 365 nm.

According to an embodiment of the invention, the monomer material absorption wavelength ranges from 311 nm to 320 nm.

According to an embodiment of the invention, the step of forming the optical alignment film having the first alignment direction and the second alignment direction on the first substrate includes the following. A photomask exposing the first area of the first substrate is provided. The alignment solution on the first area of the first substrate is exposed to a first polarized light of the polarized light, and the first polarized light passes through the photomask. Here, the first polarized light passing through the photomask and irradiating the first area polymerizes the photo-polymerization alignment material in the alignment solution, so as to define the first alignment direction. The alignment solution on the entire first substrate is exposed to a second polarized light of the polarized light. Here, the second polarized light has a polarization direction different from a polarization direction of the first polarized light, and the second polarized light polymerizes the photo-polymerization alignment material in the alignment solution on the second area, so as to define the second alignment direction.

According to another embodiment of the invention, the step of forming the optical alignment film having the first alignment direction and the second alignment direction on the first substrate includes the following. A photomask exposing the first area of the first substrate is provided. The composite alignment solution on the first area of the first substrate is exposed to a first polarized light of the polarized light, and the first polarized light passes through the photomask. Here, the first polarized light passing through the photomask and irradiating the first area polymerizes the photo-polymerization alignment material in the composite alignment solution, so as to define the first alignment direction. The composite alignment solution on the entire first substrate is exposed to a second polarized light of the polarized light. Here, the second polarized light has a polarization direction different from a polarization direction of the first polarized light, and the second polarized light polymerizes the photo-polymerization alignment material in the composite alignment solution on the second area, so as to define the second alignment direction.

According to an embodiment of the invention, the manufacturing method of the optical film further includes performing a pre-baking process on the alignment solution on the first substrate before the alignment solution on the first substrate is exposed to the polarized light.

According to an embodiment of the invention, the manufacturing method of the optical film further includes performing a pre-baking process on the composite liquid crystal material on the optical alignment film before the composite liquid crystal material on the optical alignment film is exposed to the first non-polarized light.

According to an embodiment of the invention, the manufacturing method of the optical film further includes performing a pre-baking process on the composite alignment solution on the first substrate before the composite alignment solution on the first substrate is exposed to the polarized light.

According to an embodiment of the invention, the manufacturing method of the optical film further includes performing a pre-baking process on the reactive liquid crystal material on the optical alignment film before the reactive liquid crystal material on the optical alignment film is exposed to the first non-polarized light.

In the invention, a manufacturing method of a stereoscopic display includes following steps. The optical film is formed on the first substrate according to the aforesaid manufacturing method of the optical film. A second substrate opposite to the first substrate of the optical film is provided. A liquid crystal layer is formed between the first substrate and the second substrate.

Based on the above, in the optical film described in the embodiments, the monomer material is doped into the photo-polymerization alignment material and/or the alignment solution. The monomer material is exposed to the polarized light to form networks on surfaces of the photo-polymerization alignment material and the reactive liquid crystal material. Thereby, the surface anchoring force of the secondary alignment and the alignment force of the reactive liquid crystal material can be enhanced. Namely, the issue of unfavorable secondary alignment can be resolved, and phase retardations at even or odd zones can be equalized. Moreover, owing to the arrangement of the optical film in the stereoscopic display, the color shift problem caused by unfavorable secondary alignment can be solved, and thus the quality of the stereo image can be ameliorated.

Several exemplary embodiments accompanied with figures are described in detail below to further describe the invention in details.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1A to FIG. 1I are schematic side views illustrating a manufacturing process of an optical film according to an embodiment of the invention.

FIG. 2 is a schematic view illustrating alignment of a liquid crystal material according to a reference example.

FIG. 3 is a schematic view illustrating alignment of a reactive liquid crystal material according to the embodiment of the invention.

FIG. 4A to FIG. 4I are schematic side views illustrating a manufacturing process of an optical film according to another embodiment of the invention.

FIG. 5 is a cross-sectional view illustrating a stereoscopic display according to an embodiment of the invention.

### DETAILED DESCRIPTION OF DISCLOSED EMBODIMENTS

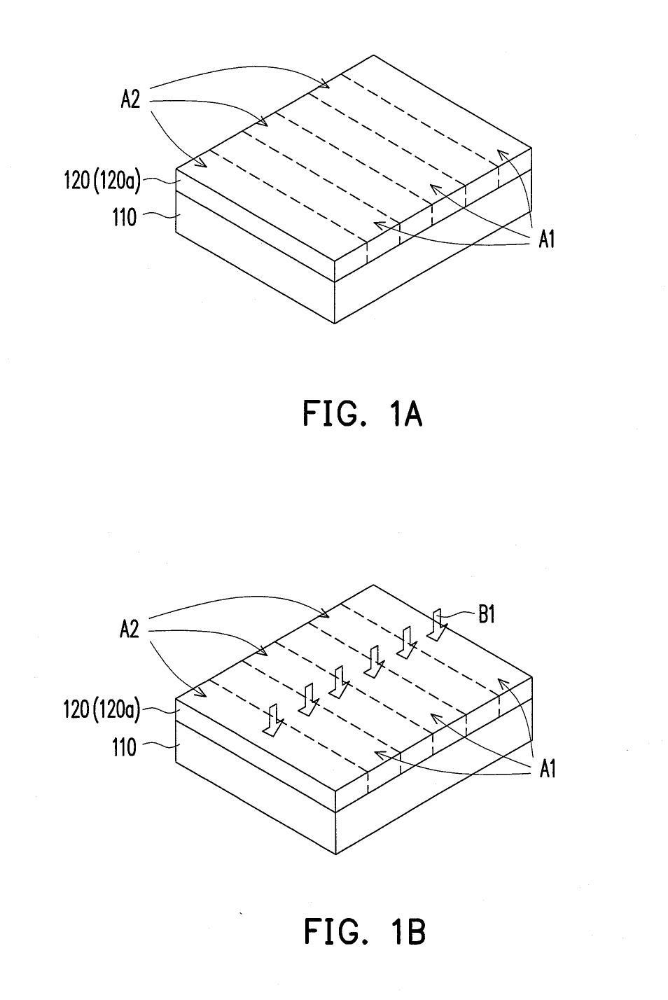

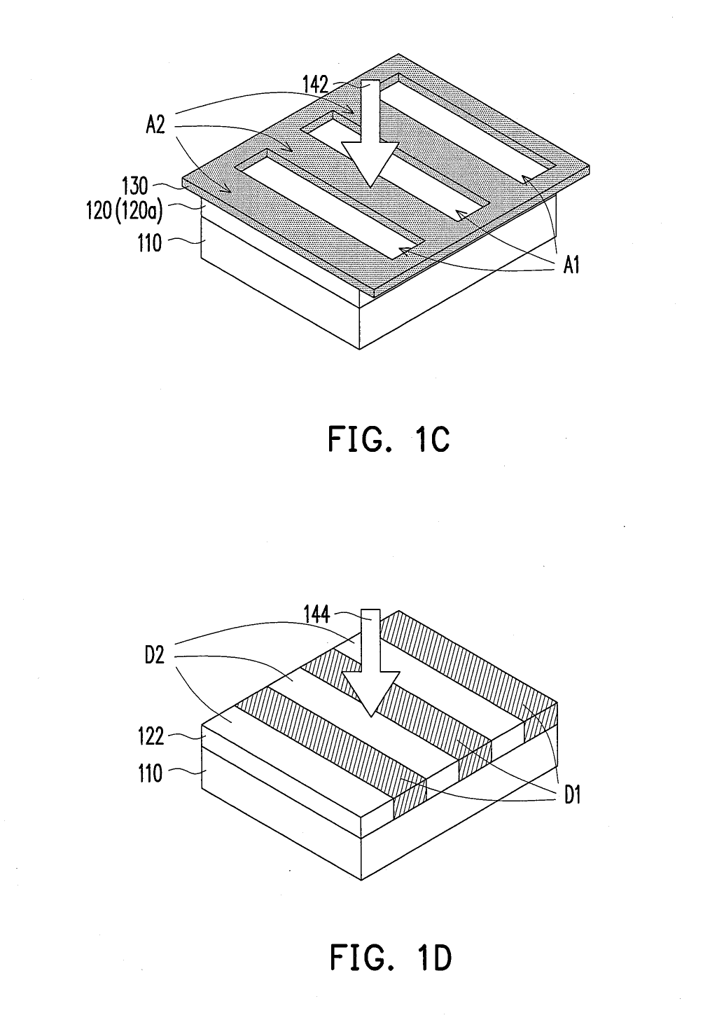

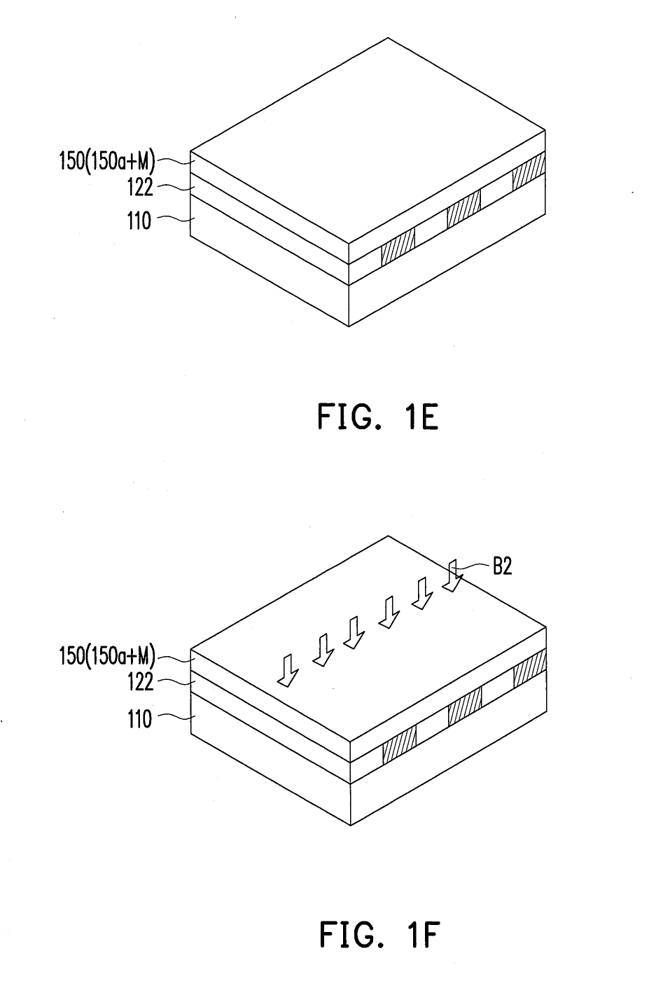

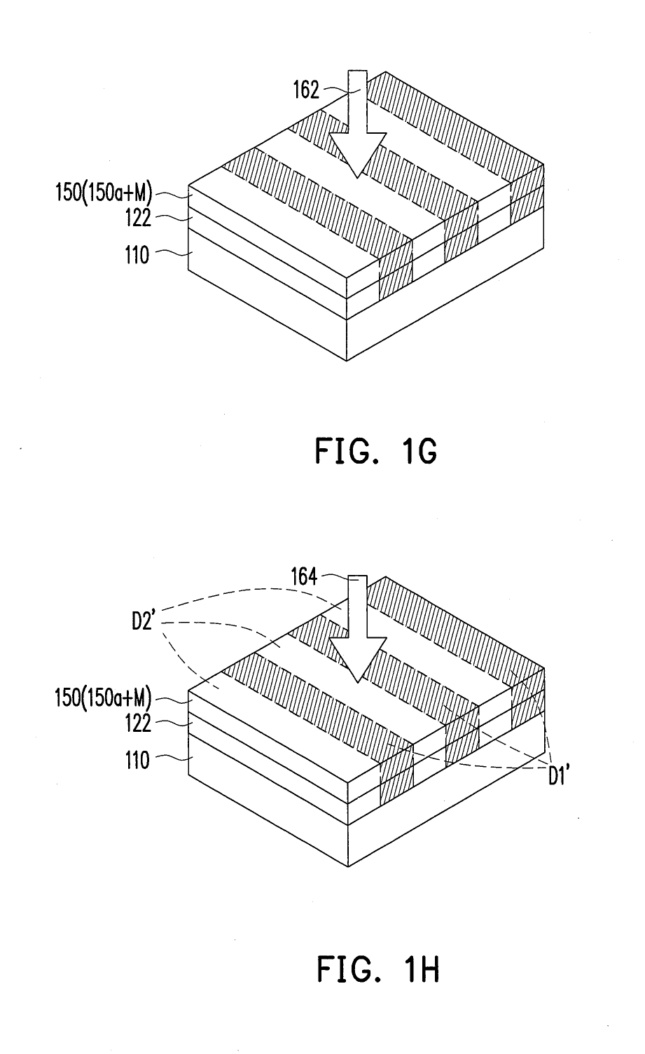

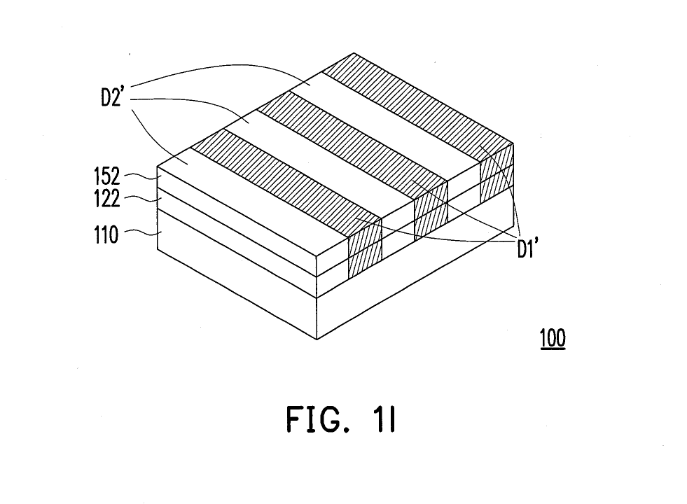

FIG. 1A to FIG. 1I are schematic side views illustrating a manufacturing process of an optical film according to an embodiment of the invention.

With reference to FIG. 1A, an alignment solution 120 is coated onto a first substrate 110 which has a first area A1 and a second area A2, and the first area A1 and the second area A2 are alternately arranged. In the present embodiment, the alignment solution 120 may be a photo-polymerization alignment material 120a, but the present invention is not limited thereto. In addition, the alignment solution 120 may be coated onto the first substrate 110 by spin coating, slit coating, or in any other manner well known to people skilled in the art, and thus no further description is provided hereinafter.

With reference to FIG. 1B, a pre-baking process B1 is performed on the alignment solution 120. Note that the temperature control and the time control of the pre-baking process B1 pose an impact on the subsequent manufacturing processes; accordingly, the temperature and the time at which the pre-baking process B1 is performed are determined by actual demands. In the present embodiment, the pre-baking process B1 is performed at the temperature ranging from 90° C. to 150° C., for instance, and the pre-baking process B1 is performed for 15˜30 minutes, for instance.

With reference to FIG. 1C, a photomask 130 exposing the first area A1 of the first substrate 110 is provided. The alignment solution 120 on the first area A1 of the first substrate 110 is exposed to a first polarized light 142, and the first polarized light 142 passes through the photomask 130. At this time, the photo-polymerization alignment material 120a in the alignment solution 120 is irradiated by the first polarized light 142 and is thus polymerized, so as to define a first alignment direction D1 on the first area A1 of the first substrate 110.

With reference to FIG. 1D, the photomask 130 is removed, and the alignment solution 120 on the first substrate 110 is exposed to a second polarized light 144. According to the present embodiment, the second polarized light 144, for instance, irradiates the alignment solution 120 on the entire substrate 110, for instance. At this time, the photo-polymerization alignment material 120a (shown in FIG. 1C) in the alignment solution 120 on the second area A2 is irradiated by the second polarized light 144 and is thus polymerized, so as to define a second alignment direction D2. Note that the polarization direction of the second polarized light 144 is different from the polarization direction of the first polarized light 142. Besides, in the present embodiment, the first polarized light 142 and the second polarized light 144 may be polarized ultraviolet light. So far, the fabrication of the optical alignment film 122 is initially completed, and the optical alignment film 122 has the first alignment direction D1 on the first area A1 and has the second alignment direction D2 on the area A2.

With reference to FIG. 1E, a composite liquid crystal material 150 is coated onto the optical alignment film 122 that has the first alignment direction D1 and the second alignment direction D2. In the present embodiment, the composite liquid crystal material 150 includes a reactive liquid crystal material 150a and a monomer material M. To be more specific, the monomer material M may be a high polymer monomer, a low polymer monomer, a bifunctional monomer, a one-sided chain monomer, or a combination thereof. In the present embodiment, the monomer material M may be the compound represented by the following formulas (1)˜(7).

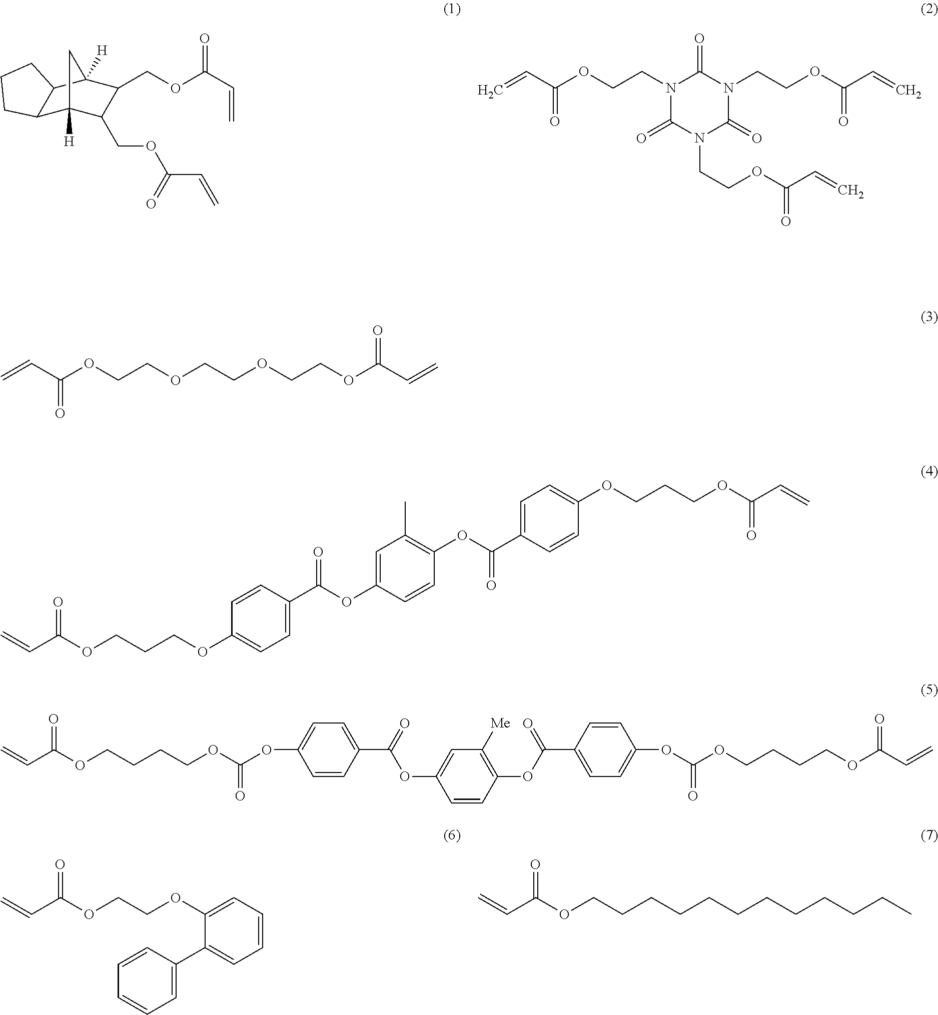

An absorption wavelength of the monomer material M ranges from 311 nm to 320 nm. In addition, the composite liquid crystal material 150 may be coated onto the first substrate 110 by spin coating, slit coating, or in any other manner well known to people skilled in the art, and thus no further description is provided hereinafter.

With reference to FIG. 1F, a pre-baking process B2 is performed on the composite liquid crystal material 150. In the present embodiment, the pre-baking process B2 is performed at the temperature ranging from 80° C. to 130° C., for instance, and the pre-baking process B2 is performed for 30 seconds-1 minute, for instance. However, practically speaking, the temperature and the time at which the pre-baking process B2 is performed are determined by actual demands, and thus the invention is not limited thereto.

With reference to FIG. 1G, the composite liquid crystal material 150 is provided with a first non-polarized light 162 having the absorption wavelength of the monomer material M. In the present embodiment, a wavelength of the first non-polarized light 162 ranges from 254 nm to 365 nm, and the absorption wavelength of the monomer material M (ranging from 311 nm to 320 nm) falls within the wavelength range of the first non-polarized light 162. Hence, when the composite liquid crystal material 150 on the optical alignment film 122 is exposed to the first non-polarized light 162, the monomer material M absorbs the first non-polarized light 162 and then reacts with the reactive liquid crystal material 150a.

In particular, after the monomer material M is exposed to the first non-polarized light 162, networks (not shown in FIG. 1G but described below) are formed on surfaces of the photo-polymerization alignment material 120a and the reactive liquid crystal material 150a, so as to enhance the surface anchoring force of the secondary alignment. Note that the reactive liquid crystal material 150a may be continuously stacked, and thus the alignment force of the reactive liquid crystal material 150a is enhanced together with the enhancement of the surface anchoring force of the secondary alignment. Thereby, after the reactive liquid crystal material 150a is arranged along the first and second alignment directions D1 and D2 of the optical alignment film 122, equivalent alignment forces may be generated.

With reference to FIG. 1H, a second non-polarized light 164 having an absorption wavelength of the reactive liquid crystal material 150a is provided. In the present embodiment, a wavelength of the second non-polarized light 164 is 365 nm, for instance. The reactive liquid crystal material 150a on the optical alignment film 122 is exposed to the second non-polarized light 164, such that the reactive liquid crystal material 150a is solidified along the first alignment direction D1 and the second alignment direction D2 of the optical alignment film 122. Thereby, a first alignment direction D1′ and a second alignment direction D2′ of the secondary alignment on the phase retardation film (not shown) can be defined.

With reference to FIG. 1I, so far, the fabrication of the optical film 100 described in the present embodiment is completed, and the optical film 100 includes the first substrate 110, the optical alignment film 122, and a phase retardation film 152. Besides, the phase retardation film 152 has the same alignment directions as the first and second alignment directions D1 and D2 of the optical alignment film 122. Here, the first and second alignment directions D1′ and D2′ of the phase retardation film 152, may transform the linear polarization light into a left-hand circular polarization light and a right-hand circular polarization light, for instance.

To be more specific, in the optical film 100, the first alignment direction D1 and the second alignment direction D2 of the optical alignment film 122 define the direction along which the reactive liquid crystal material 150a is solidified. In addition, the monomer material M doped into the reactive liquid crystal material 150a is exposed to the first non-polarized light 162, so as to enhance both the surface anchoring force of the secondary alignment and the alignment force of the reactive liquid crystal material 150a. As such, after exposure to the second non-polarized light 164, the alignment force along the second alignment direction D2′ of the phase retardation film 152 may be equivalent to the alignment force along the first alignment direction D1′.

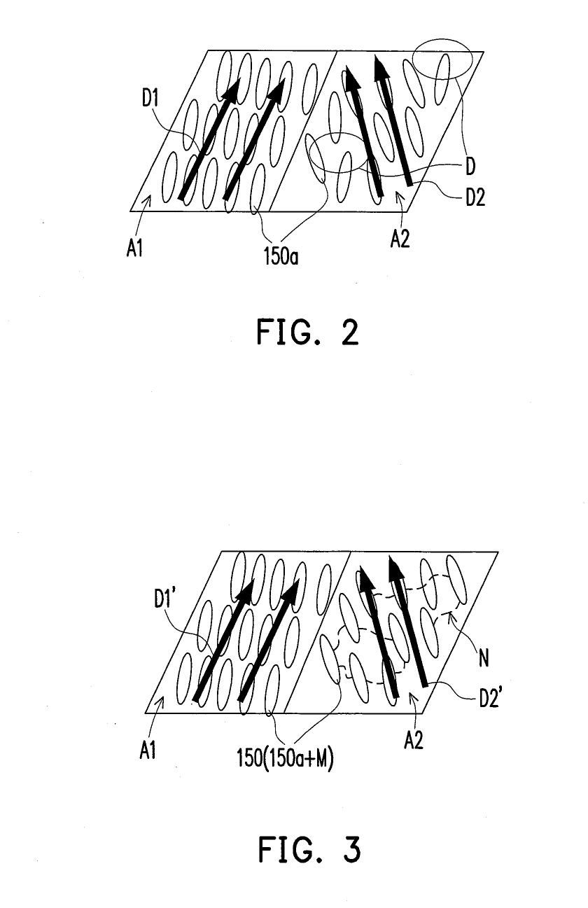

The enhancement of both the surface anchoring force of the secondary alignment and the alignment force of the reactive liquid crystal material through the monomer material M in the optical film 100 described in the present embodiment will be further elaborated with reference to FIG. 2 and FIG. 3.

FIG. 2 is a schematic view illustrating alignment of a liquid crystal material according to a reference example, and FIG. 3 is a schematic view illustrating alignment of a reactive liquid crystal material according to the embodiment of the invention. Here, FIG. 3 is a schematic view exemplarily illustrating the alignment taken along the sectional line A-A′ depicted in FIG. 1I.

It should be mentioned that the structure provided in the reference example is similar to the structure described in the present embodiment. The difference therebetween lies in that the reactive liquid crystal material 150a in the reference example is not mixed with the monomer material M, while the composite liquid crystal material 150 described in the present embodiment includes the reactive liquid crystal material 150a and the monomer material M. With reference to FIG. 2, the first alignment direction D1 is, for instance, from the upper-left corner to the lower-right corner, while the second alignment direction D2 is, for instance, from the lower-left corner to the upper-right corner. In the reference example, the reactive liquid crystal material 150a is densely arranged along the first alignment direction D1, and the alignment result is rather satisfactory, which indicates that the alignment force along the first alignment direction D1 is sufficient in the reference example. Nonetheless, the reactive liquid crystal material 150a is loosely arranged along the second alignment direction D2, and parts of the reactive liquid crystal material 150a cannot be arranged along the second alignment direction D2. In other words, the alignment force along the second alignment direction D2 is insufficient according to the reference example, and thus issues of unsatisfactory alignment D (e.g., alignment defects D) may arise.

On the other hand, with reference to FIG. 3, in the composite liquid crystal material 150 described in the present embodiment, the monomer material M is mixed with the reactive liquid crystal material 150a. Since the monomer material M is exposed to the non-polarized light, networks N are generated on the surfaces of the photo-polymerization alignment material and the reactive liquid crystal material 150a. Thereby, the surface anchoring force of the secondary alignment and the alignment force of the reactive liquid crystal material can be enhanced. In conclusion, as shown in FIG. 3, the reactive liquid crystal material 150a is densely arranged along both the first alignment direction D1′ and the second alignment direction D2′, and the alignment result is rather satisfactory. Namely, according to the present embodiment, the alignment force along the second alignment direction D2′ may be equivalent to the alignment force along the first alignment direction D′. Albeit the formation of the networks N along the first alignment direction D′, the networks N have limited effects because the alignment force along the first alignment direction D1′ is sufficient. That is to say, the formation of the networks N mostly aims at enhancing the alignment force along the second alignment direction D2′.

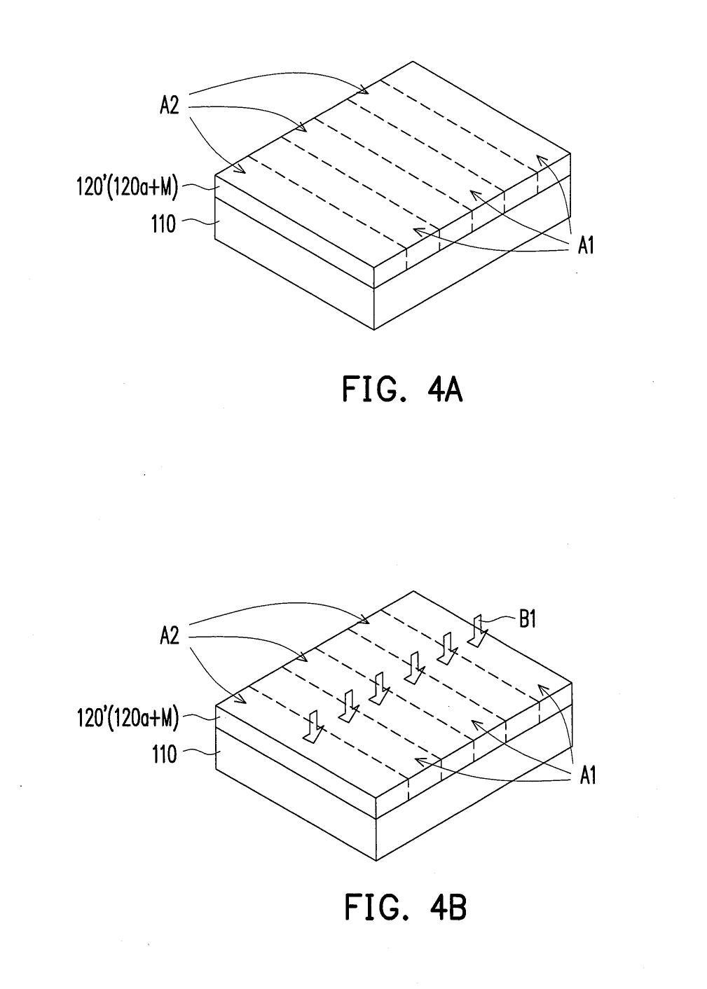

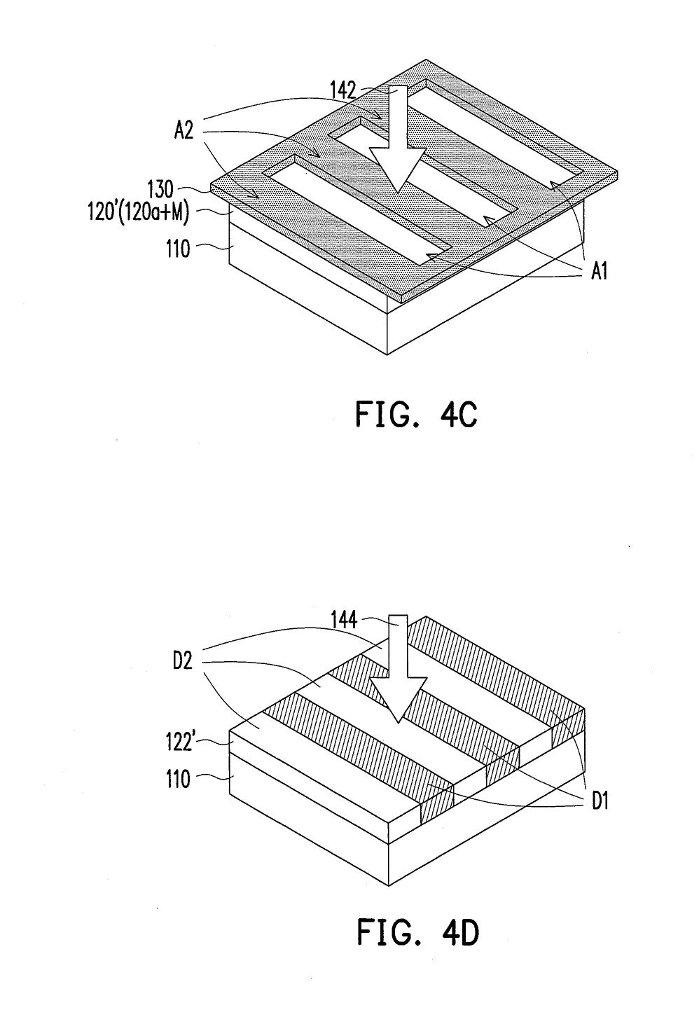

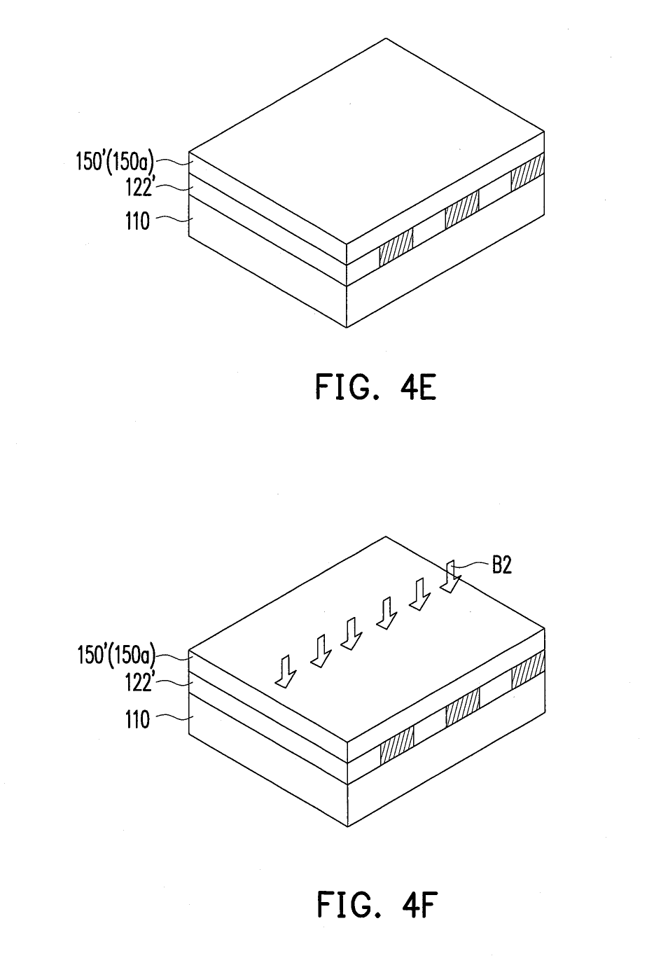

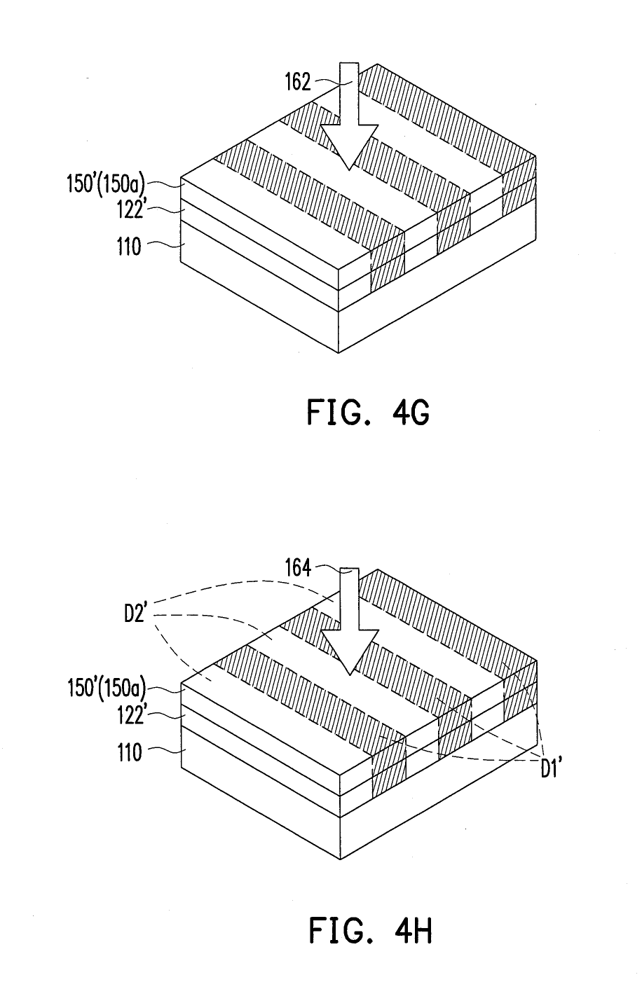

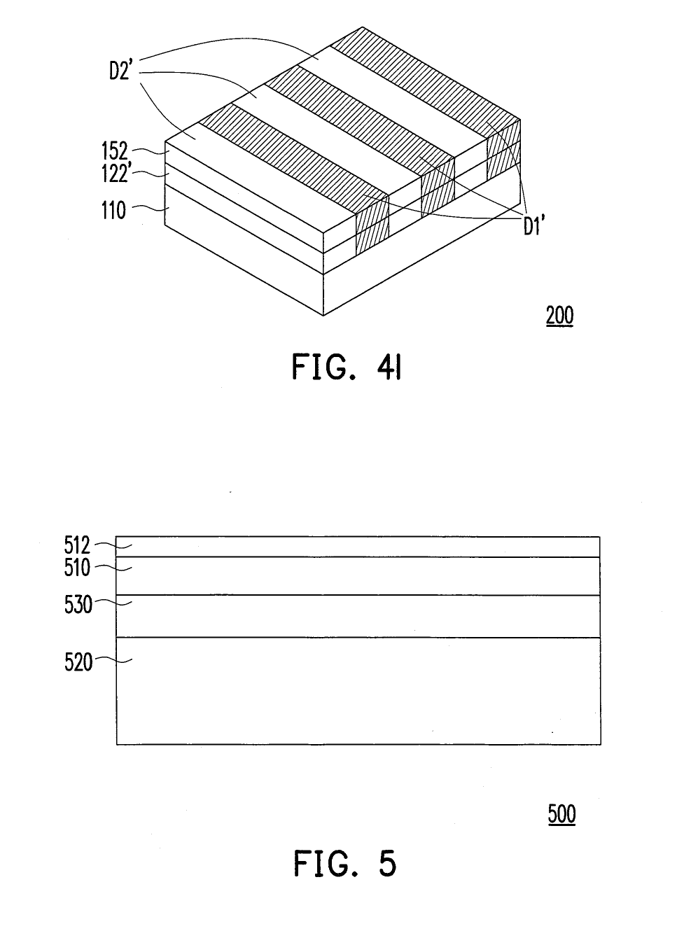

Additionally, the monomer material not only can be doped into the reactive liquid crystal material, as described above, but also can be doped into the alignment solution or into both the reactive liquid crystal material and the alignment solution according to other embodiments of the invention. According to the following embodiment shown in FIG. 4A to FIG. 4I, the monomer material is doped into the alignment solution.

FIG. 4A to FIG. 4I are schematic side views illustrating a manufacturing process of an optical film according to another embodiment of the invention. With reference to FIG. 4A to FIG. 4I, the manufacturing process of the optical film 200 in the present embodiment is similar to that shown in FIG. 1A to FIG. 1I, while the difference therebetween rests in that the composite alignment solution 120′ described in the step shown in FIG. 4A has both the photo-polymerization alignment material 120a and the monomer material M. Besides, in the step shown in FIG. 4E, the film coated onto the optical alignment film 122′ does not contain the monomer material M but simply contains the reactive liquid crystal material 150′ (i.e., the reactive liquid crystal material 150a).

To be more specific, as shown in FIG. 4A, the composite alignment solution 120′ that includes the photo-polymerization alignment material 120a and the monomer material M is coated onto the first substrate 110. The first substrate 110 has a first area A1 and a second area A2, and the first area A1 and the second area A2 are alternately arranged. The monomer material M described in the present embodiment is similar to that described in the previous embodiment, and the method of coating the composite alignment solution 120′ onto the first substrate 110 is similar to the method of coating the alignment solution 120 onto the first substrate 110 shown in FIG. 1A. Hence, no further description is provided hereinafter.

With reference to FIG. 4B, a pre-baking process B1 is performed on the composite alignment solution 120′. Note that the temperature control and the time control of the pre-baking process B1 pose an impact on the subsequent manufacturing processes; accordingly, the temperature and the time at which the pre-baking process B1 is performed are determined by actual demands. In the present embodiment, the pre-baking process B1 is performed at the temperature ranging from 90° C. to 150° C., for instance, and the pre-baking process B1 is performed for 1530 minutes, for instance.

With reference to FIG. 4C, a photomask 130 exposing the first area A1 of the first substrate 110 is provided. The composite alignment solution 120′ on the first area A1 of the first substrate 110 to a first polarized light 142, and the first polarized light 142 passes through the photomask 130. At this time, the photo-polymerization alignment material 120a in the composite alignment solution 120′ is irradiated by the first polarized light 142 and is thus polymerized, so as to define a first alignment direction D1 on the first area A1 of the first substrate 110.

With reference to FIG. 4D, the photomask 130 is removed, and the composite alignment solution 120′ on the first substrate 110 is exposed to a second polarized light 144. According to the present embodiment, the second polarized light 144, for instance, irradiates the composite alignment solution 120′ on the entire substrate 110, for instance. At this time, the photo-polymerization alignment material 120a (shown in FIG. 4C) in the composite alignment solution 120′ on the second area A2 is irradiated by the second polarized light 144 and is thus polymerized, so as to define a second alignment direction D2. Note that the polarization direction of the second polarized light 144 is different from the polarization direction of the first polarized light 142. Besides, in the present embodiment, the first polarized light 142 and the second polarized light 144 may be polarized ultraviolet light. So far, the fabrication of the optical alignment film 122′ is initially completed, and the optical alignment film 122′ has the first alignment direction D1 on the first area A1 and has the second alignment direction D2 on the area A2, respectively.

With reference to FIG. 4E, a reactive liquid crystal material 150′ is coated onto the optical alignment film 122′ that has the first alignment direction D1 and the second alignment direction D2. In the present embodiment, the monomer material M may be doped into the alignment solution to form the composite alignment solution 120′ (shown in FIG. 4A) instead of being doped into the reactive liquid crystal material 150′. However, the invention is not limited thereto, and the monomer material in other embodiments may be doped into both the alignment solution and the reactive liquid crystal material. Since the reactive liquid crystal material 150′ is coated onto the optical alignment film 122′ in a manner similar to that shown in FIG. 1E, no further description is provided hereinafter.

With reference to FIG. 4F, a pre-baking process B2 is performed on the reactive liquid crystal material 150′. In the present embodiment, the pre-baking process B2 is performed at the temperature ranging from 80° C. to 130° C., for instance, and the pre-baking process B2 is performed for 30 seconds-1 minute, for instance. However, practically speaking, the temperature and the time at which the pre-baking process B2 is performed are determined by actual demands, and thus the invention is not limited thereto.

With reference to FIG. 4G, a first non-polarized light 162 having the absorption wavelength of the monomer material M is provided. Note that the reactive liquid crystal material 150′ described in the present embodiment is a transparent material. Accordingly, when the monomer material M is being exposed to the first non-polarized light 162, the first non-polarized light 162 may pass through the reactive liquid crystal material 150′ and then irradiate the monomer material M (shown in FIG. 4C), such that the monomer material M in the present embodiment may be transformed into the networks N on the surfaces of the photo-polymerization alignment material (shown in FIG. 4C) and the reactive liquid crystal material 150′. Thereby, the surface anchoring force of the secondary alignment and the alignment force of the reactive liquid crystal material 150′ can be enhanced.

In particular, after the monomer material M is exposed to the first non-polarized light 162, networks are formed on surfaces of the photo-polymerization alignment material and the reactive liquid crystal material 150′, so as to enhance the surface anchoring force of the secondary alignment. Note that the reactive liquid crystal material 150′ may be continuously stacked, and thus the alignment force of the reactive liquid crystal material 150′ is enhanced together with the enhancement of the surface anchoring force of the secondary alignment. Thereby, after the reactive liquid crystal material 150′ is arranged along the first and second alignment directions D1 and D2 on the optical alignment film 122′, equivalent alignment forces may be generated.

With reference to FIG. 4H, a second non-polarized light 164 having an absorption wavelength of the reactive liquid crystal material 150′ is provided. In the present embodiment, a wavelength of the second non-polarized light 164 is 365 nm, for instance. The reactive liquid crystal material 150′ on the optical alignment film 122′ is exposed to the second non-polarized light 164, such that the reactive liquid crystal material 150′ is solidified along the first alignment direction D1 and the second alignment direction D2 of the optical alignment film 122′. Thereby, a first alignment direction D1′ and a second alignment direction D2′ of the secondary alignment on the phase retardation film (not shown) can be defined.

With reference to FIG. 4I, so far, the fabrication of the optical film 200 described in the present embodiment is completed, and the optical film 200 includes the first substrate 110, the optical alignment film 122′, and a phase retardation film 152. Besides, the phase retardation film 152 has the same alignment directions as the first and second alignment directions D1 and D2 of the optical alignment film 122′. Here, the first and second alignment directions D1′ and D2′ of the phase retardation film 152 may transform the linear polarization light into a left-hand circular polarization light and a right-hand circular polarization light, for instance.

To be more specific, in the optical film 200, the first alignment direction D and the second alignment direction D2 of the optical alignment film 122′ define the direction along which the reactive liquid crystal material 150′ is solidified. In addition, the monomer material M doped into the alignment solution is exposed by the first non-polarized light 162, so as to enhance both the surface anchoring force of the secondary alignment and the alignment force of the reactive liquid crystal material 150′. As such, after exposure to the second non-polarized light 164, the alignment force along the second alignment direction D2′ of the phase retardation film 152 may be equivalent to the alignment force along the first alignment direction D1′.

When the optical film 100 or 200 formed by performing said manufacturing process is actually applied, the optical film 100 or 200 may be employed in any stereoscopic display that displays images through phase retardation. An embodiment in this regard is provided hereinafter with reference to FIG. 5.

FIG. 5 is a cross-sectional view illustrating a stereoscopic display according to an embodiment of the invention. As shown in FIG. 5, in the stereoscopic display 500 of the present embodiment, an optical film 512 is formed on a first substrate 510 by performing the manufacturing method of the optical film 100 or 200 as described in the previous two embodiments. A second substrate 520 is then formed, and the second substrate 520 is opposite to the first substrate 510 on which the optical film 512 is formed. A liquid crystal layer 530 is formed between the first substrate 510 and the second substrate 520. In the present embodiment, the first substrate 510 is a color filter substrate, for instance, and the second substrate 520 is an active device array substrate, for instance. Through the optical film 512 configured on the first substrate 510, the stereoscopic display 500 is able to transform an incident light (not shown) into a left-hand circular polarization light and a right-hand circular polarization light, and thereby a user wearing a specially designed pair of glasses may watch a stereo image on the stereoscopic display 500.

The optical film 512 of the stereoscopic display 500 described herein renders the alignment force along the second alignment direction and the alignment force along the first alignment direction equivalent. As such, the conventional color shift issue caused by unsatisfactory secondary alignment does not occur in the stereo image displayed on the stereoscopic display 500 That is to say, compared to the stereo image displayed on a conventional stereoscopic display, the stereo image displayed on the stereoscopic display 500 described in the present embodiment can have favorable quality.

To sum up, in the optical film described in the embodiments, the monomer material is doped into the photo-polymerization alignment material and/or the alignment solution. The monomer material is exposed to the polarized light to form networks on surfaces of the photo-polymerization alignment material and the reactive liquid crystal material. Since the reactive liquid crystal material may be continuously stacked, the alignment force of the reactive liquid crystal material can be enhanced after the surface anchoring force of the secondary alignment is enhanced by the networks, and phase retardation at even or odd zones can be equalized. Moreover, owing to the arrangement of the optical film in the stereoscopic display, the conventional color shift problem caused by unfavorable secondary alignment can be solved, and thus the quality of the stereo image can be ameliorated.

It will be apparent to those skilled in the art that various modifications and variations can be made to the structure of the invention without departing from the scope or spirit of the invention. In view of the foregoing, it is intended that the present invention cover modifications and variations of this invention provided they fall within the scope of the following claims and their equivalents.

What is claimed is:

1. A manufacturing method of an optical film, the manufacturing method comprising:
providing an alignment solution, the alignment solution comprising a photo-polymerization alignment material;
coating the alignment solution onto a first substrate, the first substrate having a first area and a second area;
exposing the alignment solution on the first substrate to a polarized light, so as to form an optical alignment film on the first substrate, the optical alignment film on the first area having a first alignment direction and the optical alignment film on the second area having a second alignment direction;
providing a composite liquid crystal material, the composite liquid crystal material comprising a reactive liquid crystal material and a monomer material;
coating the composite liquid crystal material onto the optical alignment film having the first alignment direction and the second alignment direction;
providing a first non-polarized light having an absorption wavelength of the monomer material and exposing the composite liquid crystal material on the optical alignment film to the first non-polarized light, such that the monomer material reacts with the reactive liquid crystal material; and
providing a second non-polarized light having an absorption wavelength of the reactive liquid crystal material and exposing the reactive liquid crystal material on the optical alignment film to the second non-polarized light, such that the reactive liquid crystal material is solidified along the first alignment direction and the second alignment direction of the optical alignment film.

2. The manufacturing method of the optical film as recited in claim 1, wherein a wavelength of the first non-polarized light ranges from 254 nm to 365 nm, and a wavelength of the second non-polarized light is 365 nm.

3. The manufacturing method of the optical film as recited in claim 1, wherein the absorption wavelength of the monomer material ranges from 311 nm to 320 nm.

4. The manufacturing method of the optical film as recited in claim 1, wherein the step of forming the optical alignment film having the first alignment direction and the second alignment direction on the first substrate comprises:
providing a photomask exposing the first area of the first substrate;
exposing the alignment solution on the first area of the first substrate to a first polarized light of the polarized light, the first polarized light passing through the photomask, wherein the first polarized light passing through the photomask and irradiating the first area polymerizes the photo-polymerization alignment material in the alignment solution, so as to define the first alignment direction; and
exposing the alignment solution on the entire first substrate to a second polarized light of the polarized light, wherein the second polarized light has a polarization direction different from a polarization direction of the first polarized light, and the second polarized light polymerizes the photo-polymerization alignment material in the alignment solution on the second area, so as to define the second alignment direction.

5. The manufacturing method of the optical film as recited in claim 1, further comprising performing a pre-baking process on the alignment solution on the first substrate before the alignment solution on the first substrate is exposed to the polarized light.

6. The manufacturing method of the optical film as recited in claim 1, further comprising performing a pre-baking process on the composite liquid crystal material on the optical alignment film before the composite liquid crystal material on the optical alignment film is exposed to the first non-polarized light.

7. A manufacturing method of an optical film, the manufacturing method comprising:
providing a composite alignment solution, the composite alignment solution comprising a photo-polymerization alignment material and a monomer material;
coating the composite alignment solution onto a first substrate, the first substrate having a first area and a second area;
exposing the composite alignment solution on the first substrate to a polarized light to form an optical alignment film on the first substrate, the optical alignment film on the first area having a first alignment direction and the optical alignment film on the second area having a second alignment direction;
providing a reactive liquid crystal material;
coating the reactive liquid crystal material onto the optical alignment film having the first alignment direction and the second alignment direction;
providing a first non-polarized light having an absorption wavelength of the monomer material and exposing the monomer material and the reactive liquid crystal material to the first non-polarized light, such that the monomer material reacts with the reactive liquid crystal material; and
providing a second non-polarized light having an absorption wavelength of the reactive liquid crystal material and exposing the reactive liquid crystal material on the optical alignment film to the second non-polarized light, such that the reactive liquid crystal material is solidified along the first alignment direction and the second alignment direction of the optical alignment film.

8. The manufacturing method of the optical film as recited in claim 7, wherein a wavelength of the first non-polarized light ranges from 254 nm to 365 nm, and a wavelength of the second non-polarized light is 365 nm.

9. The manufacturing method of the optical film as recited in claim 7, wherein the absorption wavelength of the monomer material ranges from 311 nm to 320 nm.

10. The manufacturing method of the optical film as recited in claim 7, wherein the step of forming the optical alignment film having the first alignment direction and the second alignment direction on the first substrate comprises:
providing a photomask exposing the first area of the first substrate;
exposing the composite alignment solution on the first area of the first substrate to a first polarized light of the polarized light, the first polarized light passing through the photomask, wherein the first polarized light passing through the photomask and irradiating the first area polymerizes the photo-polymerization alignment material in the composite alignment solution, so as to define the first alignment direction; and
exposing the composite alignment solution on the entire first substrate to a second polarized light of the polarized light, wherein the second polarized light has a polarization direction different from a polarization direction of the first polarized light, and the second polarized light polymerizes the photo-polymerization alignment material in the composite alignment solution on the second area, so as to define the second alignment direction.

11. The manufacturing method of the optical film as recited in claim 7, further comprising performing a pre-baking process on the composite alignment solution on the first substrate before the composite alignment solution on the first substrate is exposed to the polarized light.

12. The manufacturing method of the optical film as recited in claim 7, further comprising performing a pre-baking process on the reactive liquid crystal material on the optical alignment film before the reactive liquid crystal material on the optical alignment film is exposed to the first non-polarized light.

13. A manufacturing method of a stereoscopic display panel, the manufacturing method comprising:
forming the optical film on the first substrate according to the manufacturing method of the optical film as recited in claim 1;
providing a second substrate opposite to the first substrate of the optical film; and
forming a liquid crystal layer between the first substrate and the second substrate.
